(19) United States
(12) Patent Application Publication
(10) Pub. No.: US 2002/0121173 A1
(43) Pub. Date: Sep. 5, 2002

(54) Tubing cutter device and method

(76) Inventor: Robert Filipo, Plainfield, IL (US)

Correspondence Address: Edward D. Gilhooly, EDWARD D. GILHOOLY & ASSOCIATES, 28 E. Jackson Blvd., Suite 423, Chicago, IL, 60604, US

(21) Appl. No.: 09/796,888

(22) Filed: Mar. 2, 2001

(51) Int. Cl. B26D 3/08

(52) U.S. Cl. 83/880; 83/886; 30/95; 30/93

(57) ABSTRACT

A tubing cutter having a body rotatably supporting a cutter element and a pair of rollers adjacent an opening. The tubing is placed in the opening with the rollers and cutter element in simultaneous contact. A knob and threaded shaft advance movement of a cutter holder as the body is rotated or swung about the axis tubing to cause cutting of the tubing. Stop elements are mounted relative to the cutter element to prevent cutting prior to complete severing of the tubing to permit manual breaking of the tubing to achieve a smoother end.

### BACKGROUND OF THE INVENTION

1. Field of the Invention

The invention relates in general to cutting devices and more particularly, to a device and method for cutting sections of tubing.

2. Summary of the Prior Art

In the construction and renovation of buildings, it is a common practice to draw electrical wires, communication lines and the like through metal or plastic tubing or conduits. The tubing serves as a protection for the wire and provides a convenient receptacle for extending wire during installation.

Such tubing is ordinarily manufactured in standard lengths from metal or, in some cases, plastic where acceptable. To install tubing in conformance with the physical conditions at the site, a workman commonly cuts the tubing into desired lengths by a metal cutter. Numerous techniques of cutting are used, such as by hack saws or by cutters specifically designed to cut tubing.

A well-known cutter design includes a plurality of rollers and a circular cutter element. With such a cutter, the device is positioned on the tube with the rollers and cutter contacting the surface at a location at which a cut is desired. The tubing cutter then is manually rotated 360° around the tubing to score and eventually sever adjacent tubing portions by increasing advancement of the cutter element. Examples of prior tubing cutters are disclosed and illustrated in U.S. Pat. No. 2,502,701 issued Apr. 4, 1950 to Capewell and U.S. Pat. No. 5,515,609 issued May 14, 1996 to Sperti.

The tubing cutters, such as disclosed in the foregoing Capewell and Sperti patents, are designed to completely sever tubing during each cutting operation. When a tubing section is split entirely by a tubing cutter of a prior design, a burr or sharp edge is created at the cut end, particularly adjacent the internal conduit. As a result the cut end of the tubing is rough and jagged and can cause damage to the wires and lines being drawn through the tubing. The jagged end can also cause injury to the individual handling the but tubing. The damaged lines can create a safety hazard or be subject to operative deficiencies during use. Accordingly, it is desirable in the prior art to provide a device and method to reduce the presence of burrs and jagged edges at the cut ends of severed tubing sections.

### SUMMARY OF THE INVENTION

It is, therefore, an objective of the present invention to provide an improved cutter device and method for cutting tubing. The device and method herein disclosed reduce the presence of burrs and jagged edges of severed tubing and provides an overall smoother cut end surface than as possible in the prior art. The smoother end surface provided by the invention diminishes the likelihood of damaging cable and wire while being drawn through the cable and reduces injury to an individual as a result of contact with jagged edges and burrs. The device herein disclosed employs stop means, which limits the depth of the cut of the tubing wall and prevents the cutter element from completely severing the sections of the tubing being cut. After a predetermined depth of the cut is circumferentially made into the tubing wall, the individual ceases use of the cutter of the invention and manually snaps and breaks the tubing sections. Such a technique results in a smoother cut than possible in the prior art.

### BRIEF DESCRIPTION OF THE DRAWINGS

FIG. 1 is a front elevational view, with parts in section, of the tubing cutter of the invention; and

FIG. 2 is a side elevational view, with parts in section, of the tubing cutter of FIG. 1.

### DESCRIPTION OF THE PREFERRED EMBODIMENT

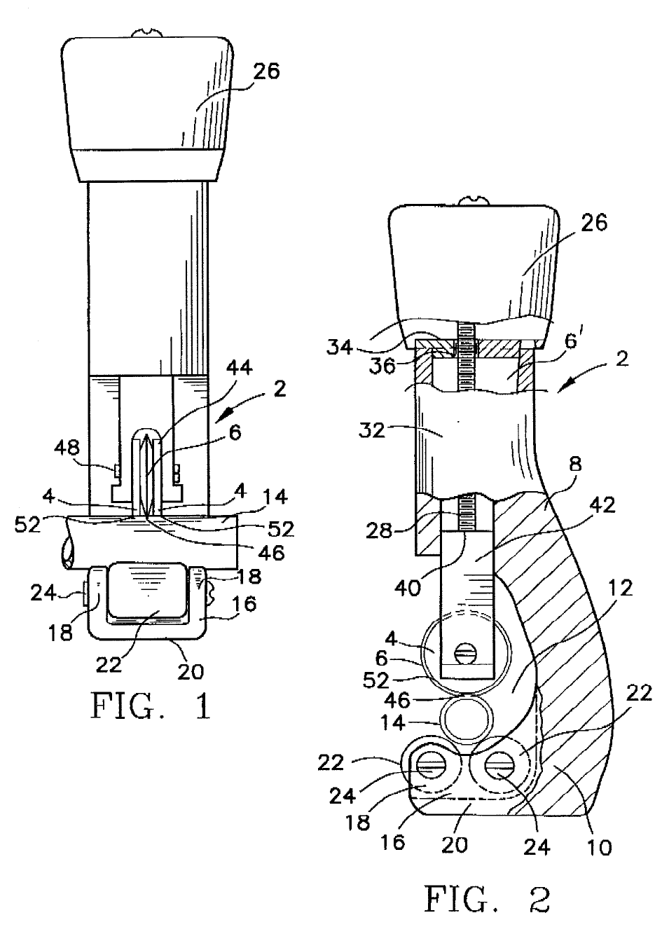

Referring now to FIGS. 1 and 2, there is illustrated the tubing cutter device of the invention, generally designated by reference numeral 2. The tubing cutter device includes cutter stops 4, which act to limit the cutting advance of a disk shaped cutter element 6 of known design in a manner to be described in detail later. The cutter device 2 is designed to cut metal or plastic tubing of a range of wall thicknesses for the purpose of providing selected lengths as needed at the job site. Although the stop elements 4 are shown in use with particular design for a tubing cutter, it is within the scope of the invention to use the technique with other cutter devices to accomplish the objective of the invention.

The cutter device 2 is provided with a main body 8 having a lower portion 10 possessing a modified “C” shaped configuration. The lower body portion 10 forms an opening 12 for positioning the cutter device 2 at a selected location on tubing 14. The bottom section 16 of lower body portion 10 is formed in a modified U-shaped configuration (FIG. 1) having opposed spaced walls 18 and a bottom integral wall 20. A pair of rollers 22 are rotatably mounted on spaced walls 18 on parallel shafts 24 in adjacent relation so that a portion of both rollers 22 simultaneously contacts the tubing 14 with the cutter element 6. A rotatably mounted knob 26 is secured to the end (not shown) of rotatable threaded shaft 28 (FIG. 2). The upper portion 32 of main body 6 is hollow forming cavity 6′ and terminates with closed upper wall portion 34. The threaded shaft 28 extends through threaded hole 36 of upper wall portion 34 into fixed securement with knob 26 through a conventional technique. As should be appreciated from the foregoing, rotation of knob 26 will cause threaded shaft 28 to move relative to upper portion 32 of the main body 8. The lower end 40 of threaded shaft 28 is rotatably secured to cutter holder 42 for fixed rotation such that movement of threaded shaft 28 relative to main body 8 will cause up and down movement of the cutter holder 42 without rotation. The cutter holder 42 is formed with flat walls and includes a lower cut-out area 44 for rotatably mounting metal cutter element 6 having disk cross section and forming a narrow cutting periphery 46. The cutter element 6 is rotatably mounted on a shaft 48, which is affixed to opposed wall portions 50 surrounding cutout area 42.

The stops 4 are also mounted on shaft 48 in spaced relationship adjacent opposed faces of cutter element 6 on opposite sides of the cut being made. As shown in FIG. 2, the stops 4 are in the form of disks having a circular cross-section terminating with a periphery 52, which are within the diameter of the cutting edge periphery 46 of the cutter element. Accordingly, the cutting edge 46 can be advanced to cut tubing 14 by swinging the body 8 circumferentially around the outer surface of tubing 14 while rotating knob 26 to advance cutter element 6 until such time as the periphery 52 of the stops 6 contact the surface of the tubing as shown in FIGS. 1 and 2. Upon contact the cutter element 6 cannot make a deeper cut. In any event the distance between the periphery 46 of the cutter element 6 and the periphery 52 of the stops 4 are selected to be less than the thickness of the tubing 14, such as, for example, greater than ½ to ¾ of the thickness of the wall of the tubing. The actual depth of the cut in tubing 14 is dependent on encountered conditions, including whether the tubing cut is sufficient to permit the tubing 16 to readily be snapped off by hand at the partial cut after removal of cutter device 2. Stops of various diameters may be interchangeable used in connection with the invention dependent on the desired depth of cut. The stops 6 may be adjustable mounted, such as each being independently mounted on opposed walls 50 with each stop being securable in fixed relationship in a conventional manner to a vertical slot (not shown) formed on the walls 50. It is further within the scope of the invention to form stops in other configurations such as plates or shoulders formed on walls 50.

What is claimed is:

1. A cutter device for partially severing the wall of tubing prior to being manually snapped off comprising,
a body having an opening for receiving the tubing, said body arranged swingable circumferentially about the surface of the tubing,
a plurality of rollers being rotatably mounted on said body adjacent said opening for contacting the tubing,
a cutter holder mounted for movement relative to said body,
a cutter element being mounted on said cutter holder for contacting the tubing simultaneously with said plurality of rollers, means for advancing said cutter element for cutting as the body is swung relative to the tubing, and
stop means for stopping the cut of the tube at a predetermined depth.

2. The cutter device according to claim I wherein said stop means includes a stop surface for contacting the surface of the tubing for establishing said predetermined depth of cut.

3. The cutter device according to claim 2 wherein said cutter element is a disk rotatably mounted on said cutter holder, said cutter element having an outermost periphery for a cutting edge.

4. The cutter device according to claim 3 wherein said stop means is mounted adjacent said cutter element.

5. The cutter device according to claim 4 wherein said stop surface is positioned inward relative to said periphery of said cutter by a predetermined distance.

6. The cutter device according to claim 5 wherein said predetermined distance establishes said cut of predetermined depth.

7. A cutter device for partially severing the wall of tubing prior to being manually snapped off comprising,
a body having an opening for receiving the tubing, said body arranged to be swingable circumferentially about the surface of the tubing,
a pair of adjacent rollers being rotatably mounted on said body adjacent said opening for contacting the tubing,
a cutter holder mounted for movement relative to said body,
a cutter element being rotatably mounted on said cutter holder for contacting the tubing simultaneously with said pair of rollers, means for advancing said cutter element towards the tubing for cutting as the body is swung relative to the tubing,
a stop mounted on said cutter holder adjacent said cutting element for stopping the cut of the tubing at a predetermined depth,
said stop means includes a stop surface for contacting the surface of the tubing for establishing said predetermined depth of cut,
said cutter element is a disk rotatably mounted on said cutter holder, said cutter element having an outermost periphery forming a cutting edge,
said stop surface is positioned inward relative to said periphery of said cutter element by a predetermined distance.
said predetermined distance establishes said cut of predetermined depth.

8. A method of cutting tubing comprising the steps of
rotating a cutter element circumferentially around the surface of the tubing to be cut,
advancing the cutter element into said tubing for cutting,
stopping said cutting by said cutter element after a predetermined partial cut of the wall of the tubing has been made, and
manually severing the tubing after said predetermined partial cut has been made.
